(19) United States
(12) Patent Application Publication
(10) Pub. No.: US 2026/0072310 A1
(43) Pub. Date: Mar. 12, 2026

(54) BACKLIGHT UNIT AND DISPLAY APPARATUS INCLUDING THE SAME

(71) Applicant: SAMSUNG ELECTRONICS CO., LTD., Suwon-si (KR)

(72) Inventors: Hyesung Han, Suwon-si (KR); Sungyeol Kim, Suwon-si (KR); Taeyeon Kim, Suwon-si (KR); Chunsoon Park, Suwon-si (KR); Hyukjun Jang, Suwon-si (KR)

(73) Assignee: SAMSUNG ELECTRONICS CO., LTD., Suwon-si (KR)

(21) Appl. No.: 19/319,145

(22) Filed: Sep. 4, 2025

Related U.S. Application Data
(63) Continuation of application No. PCT/KR2025/012334, filed on Aug. 14, 2025.

(30) Foreign Application Priority Data
Sep. 12, 2024 (KR) 10-2024-0125125
Nov. 21, 2024 (KR) 10-2024-0167537

(51) Int. Cl. G02F 1/1335; G02F 1/13357

(52) U.S. Cl. CPC G02F 1/133612; G02F 1/133601; G02F 1/133603; G02F 1/133605

(57) ABSTRACT

A display apparatus may include: a liquid crystal panel; and a backlight unit configured to provide light to the liquid crystal panel. The backlight unit includes: a substrate including an insulating layer and a conductive layer, the insulating layer defining a first part of a first surface of the substrate, and the conductive layer defining a second part of the first surface; and light emitting diodes on the first surface of the substrate; wherein the conductive layer includes: at least one power feeding pad connected to the light emitting diodes; at least one power feeding line connected to the at least one power feeding pad; and an antistatic member spaced apart from the at least one power feeding pad and the at least one power feeding line, and wherein the antistatic member includes a closed curve in which at least two of the plurality of light emitting diodes are disposed.

### CROSS-REFERENCE TO RELATED APPLICATIONS

This application is a bypass continuation of International Application No. PCT/KR2025/012334, filed on Aug. 14, 2025, which claims priority to Korean Patent Application No. 10-2024-0125125, filed on Sep. 12, 2024 in the Korean Intellectual Property Office, and Korean Patent Application No. 10-2024-0167537, filed on Nov. 21, 2024 in the Korean Intellectual Property Office, the disclosures of which are incorporated herein by reference in their entireties.

### BACKGROUND

### 1. Field

The disclosure relates to a display apparatus including a backlight unit.

### 2. Description of Background Art

Generally, a display apparatus is a type of output device configured to convert acquired or stored electrical information to visual information and display the visual information to a user.

Examples of a display apparatus include a monitor device connected to a personal computer, a server computer, or the like; a portable computer device; a navigation terminal device; a general television device; an Internet protocol television (IPTV) device; a portable terminal device such as a smart phone, a tablet PC, a personal digital assistant (PDA), a cellular phone, or the like; various display apparatuses used to reproduce an image such as an advertisement or a movie in an industrial field; various other audio/video systems; or the like.

The display apparatus may include a light source module to convert the electrical information to the visual information. The light source module may include a plurality of light sources configured to independently emit light.

During manufacturing, use, or maintenance of the display apparatus, static electricity may be generated and cause damage to the light sources. The display apparatus may include an antistatic member to suppress or prevent damage to the light sources caused by static electricity.

### SUMMARY

Provided are a backlight unit including an antistatic member having an improved shape or structure to enhance the stability of a light source that has become vulnerable to electrostatic discharge due to the thinning of circuit patterns such as a power feeding line on a substrate, and a display apparatus including the same.

Further, provided are a backlight unit including an antistatic member configured to substantially surround a light emitting diode and a power feeding line to improve antistatic performance in all directions, and a display apparatus including the same.

Aspects of the present disclosure are not limited to the above, and other aspects that are not described above will be clearly understood by those skilled in the art from the following detailed description.

According to an aspect of the disclosure, a display apparatus may include: a liquid crystal panel; and a backlight unit configured to provide light to the liquid crystal panel. The backlight unit may include: a substrate including an insulating layer and a conductive layer, the insulating layer defining a first part of a first surface of the substrate, and the conductive layer defining a second part of the first surface; and a plurality of light emitting diodes on the first surface of the substrate; wherein the conductive layer may include: at least one power feeding pad electrically connected to the plurality of light emitting diodes; at least one power feeding line connected to the at least one power feeding pad; and an antistatic member spaced apart from the at least one power feeding pad and the at least one power feeding line so as not to be connected to the at least one power feeding pad and the at least one power feeding line, and wherein the antistatic member includes a closed curve in which at least two of the plurality of light emitting diodes are disposed.

According to an aspect of the disclosure, a display apparatus may include: a liquid crystal panel; and a backlight unit configured to provide light to the liquid crystal panel. The backlight unit may include: a substrate including an insulating layer and a conductive layer, the insulating layer defining a first part of a first surface of the substrate, and the conductive layer defining a second part of the first surface; and a plurality of light emitting diodes on the first surface of the substrate, the plurality of light emitting diodes including a first light emitting diode and a second light emitting diode, wherein the conductive layer may include: at least one power feeding pad in contact with the plurality of light emitting diodes; at least one power feeding line connected to the at least one power feeding pad; and an antistatic member spaced apart from the at least one power feeding pad and the at least one power feeding line so as not to be connected to the at least one power feeding pad and the at least one power feeding line, and wherein the antistatic member extends, along opposite sides of the at least one power feeding line, from opposite sides of the first light emitting diode to opposite sides of the second light emitting diode.

According to an aspect of the disclosure, a backlight unit of a display apparatus may include: a substrate including an insulating layer and a conductive layer, the insulating layer defining a first part of a first surface of the substrate, and the conductive layer defining a second part of the first surface; and a plurality of light emitting diodes on the first surface of the substrate; wherein the conductive layer may include: at least one power feeding pad connected to the plurality of light emitting diodes; at least one power feeding line connected to the at least one power feeding pad; and an antistatic member spaced apart from the at least one power feeding pad and the at least one power feeding line so as not to be connected to the at least one power feeding pad and the at least one power feeding line, and wherein the antistatic member includes a shape in which at least two of the plurality of light emitting diodes are disposed.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating a display apparatus according to an embodiment;

FIG. 2 is an exploded view of a display apparatus according to an embodiment;

FIG. 3 is a view illustrating a cross-section of a liquid crystal panel of a display apparatus according to an embodiment;

FIG. 4 is an exploded view of a backlight unit according to an embodiment;

FIG. 5 is a plan view of a light source module for explaining the concept of a dimming block in a backlight unit according to an embodiment;

FIG. 6 is a perspective view showing an enlarged view of a part A of FIG. 5;

FIG. 7 is an exploded view of the light source shown in FIG. 6;

FIG. 8 is an enlarged view of a part B of FIG. 5 and illustrates an example of a dimming block of a backlight unit according to an embodiment;

FIG. 9 is a cross-sectional view taken along a line C-C′ of FIG. 8;

FIG. 10 is a plan view showing two adjacent dimming blocks among a plurality of dimming blocks in a backlight unit according to an embodiment;

FIG. 11 illustrates some of the light emitting diodes among a plurality of light emitting diodes in a backlight unit according to an embodiment;

FIG. 12 illustrates an example of a dimming block in a backlight unit according to an embodiment;

FIG. 13 illustrates some of the light emitting diodes among a plurality of light emitting diodes in a backlight unit according to an embodiment; and

FIG. 14 illustrates an example of a dimming block in a backlight unit according to an embodiment.

### DETAILED DESCRIPTION

The embodiments described in the disclosure and shown in the drawings are non-limiting examples, and various modifications to the example embodiment may be made at the time of filing of the disclosure. The various modifications are included within the spirit and scope of the disclosure.

Like numbers refer to like elements throughout the description of the drawings.

The singular form of a noun corresponding to an item may include one or a plurality of the items unless clearly indicated otherwise in a related context.

In this document, phrases, such as “A or B,” “at least one of A and B,” “at least one of A or B,” “A, B or C,” “at least one of A, B and C,” and “at least one of A, B, or C,” may include any one or all possible combinations of items listed together in the corresponding phrase among the phrases.

The terms of “˜part,” “˜module” and “˜member” may be implemented in hardware or software. In some embodiments, a plurality of “˜parts,” “˜modules” and “˜members” may be implemented as a single component. In some embodiments, a single “˜part,” “˜module” and “˜member” may include multiple components.

The terms used herein are for the purpose of describing the embodiments and are not intended to restrict and/or to limit the disclosure. The singular expressions herein may include plural expressions, unless the context clearly dictates otherwise. In addition, the terms “comprises,” “includes,” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that when a certain component is referred to as being “connected to,” “coupled to,” “supported by,” or “in contact with” another component, it may be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it may be directly on the other component or intervening components may also be present.

Meanwhile, the terms such as “vertical direction,” “front-rear direction,” and the like used in the following description are defined based on the accompanying drawings, and the shapes and positions of the respective components are not limited by these terms. For example, the term “front” may refer to the +X direction shown in the drawings, and the term “rear” may refer to the −X direction. The term “upward” may refer to the +Z direction, and the term “downward” may refer to the −Z direction as shown in the drawings. The terms “leftward” and “rightward” may refer to the +Y and −Y directions, respectively. The term “vertical direction” may refer to the Z direction in the drawings, and the term “horizontal direction” may refer to the Y direction. However, in some drawings, the +X direction may be referred to as “upward,” and the −X direction may be referred to as “downward.”

Hereinafter, non-limiting example embodiments according to the disclosure will be described in detail with reference to the accompanying drawings

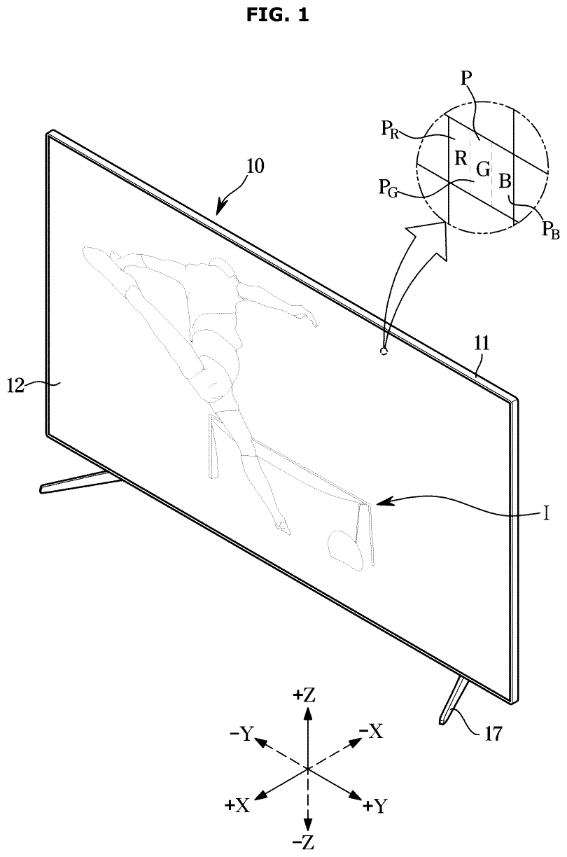

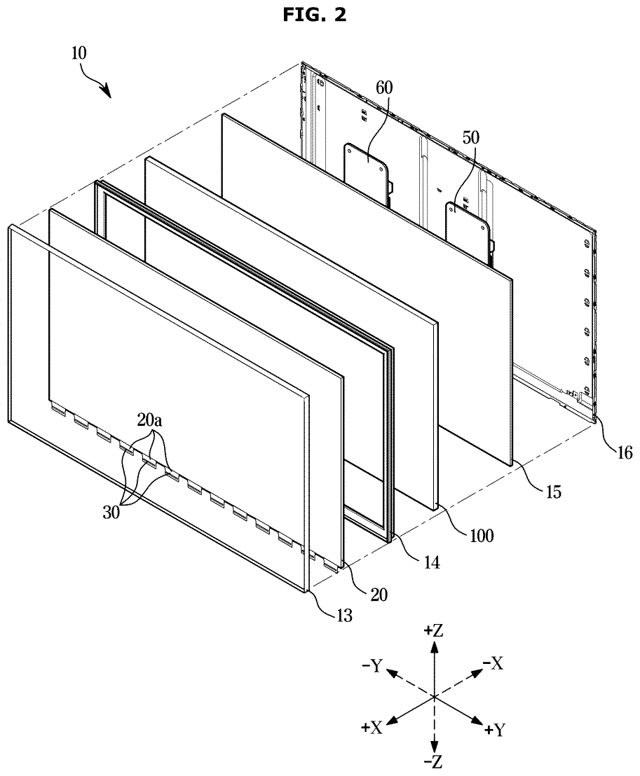

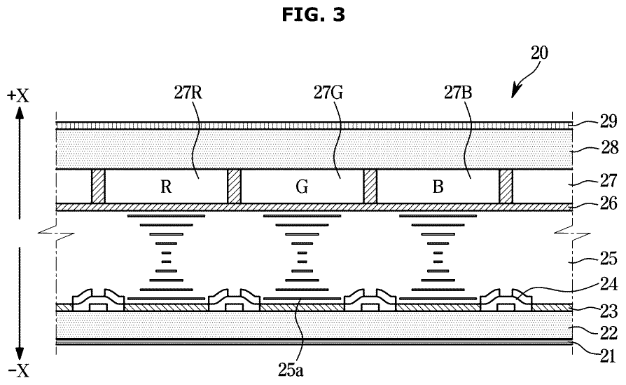

FIG. 1 is a view illustrating a display apparatus according to an embodiment. FIG. 2 is an exploded view of a display apparatus according to an embodiment. FIG. 3 is a view illustrating a cross-section of a liquid crystal panel of a display apparatus according to an embodiment.

Referring to FIG. 1, the display apparatus 10 may be a device capable of processing an image signal received from the outside and visually displaying the processed image. Hereinafter, an example in which the display apparatus 10 is a television (TV) is described, but embodiments of the disclosure are not limited thereto. For example, the display apparatus 10 may be implemented in various forms such as a monitor, a portable multimedia device, a portable communication device, and the like, and the forms of the display apparatus 10 are not limited in the case of a device configured to visually display an image.

In addition, the display apparatus 10 may be a large format display (LFD) installed outside such as on a rooftop of a building or at a bus stop. Here, the outside is not necessarily limited to the outdoors, and the display apparatus 10 according to an embodiment may be installed in a place in which a large number of people may enter and exit even in the case of indoors such as a subway station, a shopping mall, a movie theater, a company, a store, or the like.

The display apparatus 10 may receive content data including video data and audio data from various content sources, and output a video and an audio respectively corresponding to the video data and the audio data. For example, the display apparatus 10 may receive content data through a broadcast reception antenna or a wired cable, receive content data from a content reproduction device, or receive content data from a content providing server of a content provider.

As shown in FIG. 1, the display apparatus 10 may include a main body 11, a screen 12 configured to display an image I, and a support 17 provided under the main body 11 to support the main body 11.

The main body 11 may form an appearance of the display apparatus 10, and components configured to cause the display apparatus 10 to display the image I or perform various functions may be provided in the main body 11. The main body 11 shown in FIG. 1 has a flat plate shape, but the shape of the main body 11 is not limited to the case shown in FIG. 1. For example, the main body 11 may have a curved plate shape.

The screen 12 may be formed on a front surface of the main body 11, and may display the image I. For example, the screen 12 may display a still image or a video. Further, the screen 12 may display a two-dimensional flat image or a three-dimensional stereoscopic image using the parallax of a user's eyes.

A plurality of pixels P may be formed on the screen 12, and the image I displayed on the screen 12 may be formed by light emitted from each of the plurality of pixels P. For example, the image I may be formed on the screen 12 by combining the light emitted by the plurality of pixels P like a mosaic.

Each of the plurality of pixels P may emit light of various brightness and colors. For example, each of the plurality of pixels P may include a self-luminous light-emitting panel (e.g., a light-emitting diode panel) capable of directly emitting light, or a non-self-luminous light-emitting panel capable of allowing light emitted by a backlight unit or the like to pass therethrough or blocking the light (e.g., a liquid crystal panel).

In order to emit light of various colors, each of the plurality of pixels P may include sub-pixels.

The sub-pixels may include a red sub-pixel PR capable of emitting red light, a green sub-pixel PG capable of emitting green light, and a blue sub-pixel PB capable of emitting blue light. For example, the red light may be light of a wavelength from approximately 620 nanometers (nm, billionths of a meter) to 750 nm, the green light may be light of a wavelength from approximately 495 nm to 570 nm, and the blue light may be light of a wavelength from approximately 450 nm to 495 nm.

The light of various brightness and colors may be emitted from each of the plurality of pixels P by combination of the red light of the red sub-pixel PR, the green light of the green sub-pixel PG, and the blue light of the blue sub-pixel PB.

As shown in FIG. 2, various components configured to generate the image I on a screen 12 may be provided in the main body 11.

For example, the main body 11 may be provided at an inside thereof with a backlight unit 100 which may be a surface light source, a liquid crystal panel 20 configured to block the light emitted from the backlight unit 100 or allow the light to pass therethrough, a control assembly 50 configured to control operations of the backlight unit 100 and the liquid crystal panel 20, and a power assembly 60 configured to supply power to the backlight unit 100 and the liquid crystal panel 20. Further, the main body 11 may include a bezel 13, a frame middle mold 14, a bottom chassis 15, and a back cover 16 configured to support and fix the liquid crystal panel 20, the backlight unit 100, the control assembly 50, and the power assembly 60.

The backlight unit 100 may include a point light source configured to emit monochromatic light or white light, and may diffuse, refract, reflect, and scatter the light to convert light emitted from the point light source to uniform surface light. For example, the backlight unit 100 may include a plurality of light sources configured to emit the monochromatic light or the white light, a diffuser plate configured to diffuse light incident from the plurality of light sources, a reflective sheet configured to reflect light emitted from the plurality of light sources 111 and a back surface of the diffuser plate, and an optical sheet configured to refract and scatter light emitted from a front surface of the diffuser plate.

Like the above, the backlight unit 100 may emit the uniform surface light toward the front by diffusing, refracting, reflecting, and scattering the light emitted from the light sources.

Configurations of the backlight unit 100 will be described below in more detail.

The liquid crystal panel 20 may be provided in front of the backlight unit 100. The liquid crystal panel 20 may block the light emitted from the backlight unit 100 or allow the light to pass therethrough to form the image I.

A front surface of the liquid crystal panel 20 may form the screen 12 of the above-described display apparatus 10, and the liquid crystal panel 20 may include the plurality of pixels P. In the liquid crystal panel 20, the plurality of pixels P may each be controlled to independently block the light of the backlight unit 100 or allow the light to pass therethrough, and the light passing through the plurality of pixels P may form the image I displayed on the screen S.

For example, as shown in FIG. 3, the liquid crystal panel 20 may include a first polarization film 21, a first transparent substrate 22, a pixel electrode 23, a thin film transistor 24, a liquid crystal layer 25, a common electrode 26, at least one color filter 27, a second transparent substrate 28, and a second polarization film 29.

The first transparent substrate 22 and the second transparent substrate 28 may fix and support the pixel electrode 23, the thin film transistor 24, the liquid crystal layer 25, the common electrode 26, and the at least one color filter 27. The first transparent substrate 22 and the second transparent substrate 28 may be composed of tempered glass or a transparent resin.

The first polarization film 21 and the second polarization film 29 may be respectively provided at outer sides of the first transparent substrate 22 and the second transparent substrate 28.

Each of the first polarization film 21 and the second polarization film 29 may allow specific light to pass therethrough and block other light. For example, the first polarization film 21 may allow light having a magnetic field which oscillates in a first direction to pass therethrough and blocks other light. Further, the second polarization film 29 may allow light having a magnetic field which oscillates in a second direction to pass therethrough and blocks other light. In this case, the first direction and the second direction may be orthogonal to each other. Accordingly, a polarization direction of the light passing through the first polarization film 21 and an oscillation direction of the light passing through the second polarization film 29 are orthogonal to each other. As a result, generally, light may not pass through the first polarization film 21 and the second polarization film 29 at the same time.

The at least one color filter 27 may be provided at an inner side of the second transparent substrate 28.

The at least one color filter 27 may include, for example, a red filter 27R configured to allow red light to pass therethrough, a green filter 27G configured to allow green light to pass therethrough, and a blue filter 27B configured to allow blue light to pass therethrough, and the red filter 27R, the green filter 27G, and the blue filter 27B may be disposed in parallel. A region in which the at least one color filter 27 is formed may correspond to the above-described pixel P. A region in which the red filter 27R is formed may correspond to the red sub-pixel PR, a region in which the green filter 27G is formed may correspond to the green sub-pixel PG, and a region in which the blue filter 27B is formed may correspond to the blue sub-pixel PB.

The pixel electrode 23 may be provided at an inner side of the first transparent substrate 22, and the common electrode 26 may be provided at the inner side of the second transparent substrate 28.

The pixel electrode 23 and the common electrode 26 may be composed of a metal material that conducts electricity, and may generate an electric field for changing the arrangement of liquid crystal molecules constituting the liquid crystal layer 25 to be described below.

The pixel electrode 23 and the common electrode 26 may be composed of a transparent material, and may allow light incident from the outside to pass therethrough. For example, the pixel electrode 23 and the common electrode 26 may be composed of indium tin oxide (ITO), indium zinc oxide (IZO), a silver nanowire (Ag nanowire), a carbon nanotube (CNT), graphene, poly3,4-ethylenedioxythiophene) (PEDOT), or the like.

The thin film transistor (TFT) 24 may be provided at the inner side of the first transparent substrate 22.

The thin film transistor 24 may allow a current flowing through the pixel electrode 23 to pass therethrough or block the current. For example, an electric field may be formed or removed between the pixel electrode 23 and the common electrode 26 according to turn-on (closed) or turn-off (open) of the thin film transistor 24.

The thin film transistor 24 may be composed of poly-silicon, and may be formed by semiconductor processes such as a lithography process, a deposition process, an ion implantation process, and the like.

The liquid crystal layer 25 may be formed between the pixel electrode 23 and the common electrode 26, and may be filled with the liquid crystal molecules.

A liquid crystal indicates an intermediate state between a solid (e.g., crystal) and a liquid. Most of the liquid crystal materials may be organic compounds, their molecular shape may be a long and thin rod, and may have a crystal form in which the arrangement of the molecules is irregular in any direction, but is regular in another direction. As a result, the liquid crystal has both fluidity of the liquid and optical anisotropy of the crystal (solid).

Further, the liquid crystal may also exhibit optical properties according to a change in electric field. For example, in the liquid crystal, the direction of the arrangement of molecules constituting the liquid crystal may be changed according to the change in electric field. When the electric field is generated in the liquid crystal layer 25, the liquid crystal molecules of the liquid crystal layer 25 may be arranged according to the direction of the electric field, and when the electric field is not generated in the liquid crystal layer 25, the liquid crystal molecules may be irregularly arranged or may be arranged along an alignment layer. As a result, the optical properties of the liquid crystal layer 25 may be changed according to the presence or absence of the electric field passing through the liquid crystal layer 25.

A cable 20a configured to transmit image data to the liquid crystal panel 20, and a display driver integrated circuit 30 (DDI) configured to process digital image data and output an analog image signal may be provided at one side of the liquid crystal panel 20.

The cable 20a may electrically connect the control assembly 50 (and/or the power assembly 60) and the DDI 30, and may also electrically connect the DDI 30 and the liquid crystal panel 20. The cable 20a may include a flexible flat cable, a film cable, or the like, which may be bent.

The DDI 30 may receive the image data and power from the control assembly 50 (and/or the power assembly 60) through the cable 20a, and supplies the image data and a driving current to the liquid crystal panel 20 through the cable 20a.

Further, the cable 20a and the DDI 30 may be integrally implemented as a film cable, a chip on film (COF), a tape carrier package (TCP), or the like. In other words, the DDI 30 may be disposed on the cable 110b. However, embodiments of the disclosure are not limited thereto, and the DDI 30 may be disposed on the liquid crystal panel 20.

The control assembly 50 may include a control circuit configured to control the operations of the liquid crystal panel 20 and the backlight unit 100. The control circuit may process image data received from an external content source, transmit the image data to the liquid crystal panel 20, and transmit dimming data to the backlight unit 100.

The power assembly 60 may supply power to the liquid crystal panel 20 and the backlight unit 100 so that the backlight unit 100 outputs surface light and the liquid crystal panel 20 blocks the light from the backlight unit 100 or allows the light to pass therethrough.

The control assembly 50 and the power assembly 60 may be implemented as a printed circuit board and various circuits mounted on the printed circuit board. For example, the power circuit may include a capacitor, a coil, a resistor, a processor, and the like, and a power circuit board on which the above parts are mounted. Further, the control circuit may include a memory, a processor, and a control circuit board on which the above parts are mounted.

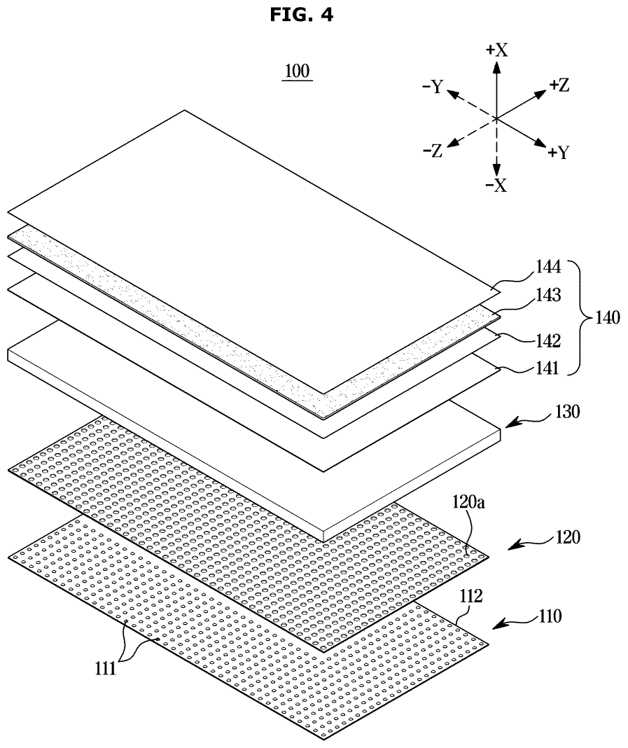

FIG. 4 is an exploded view of a backlight unit according to an embodiment.

The backlight unit 100 may include a light source module 110 configured to generate light, a reflective sheet 120 configured to reflect the light, a diffuser plate 130 configured to uniformly diffuse the light, and an optical sheet 140 configured to enhance the luminance of the emitted light.

The light source module 110 may include a plurality of light sources 111 configured to emit light, and a substrate 112 configured to support or fix the plurality of light sources 111.

The plurality of light sources 111 may be disposed in a predetermined pattern so that light may be emitted with uniform luminance. The plurality of light sources 111 may be disposed so that distances between one light source and light sources adjacent thereto may become the same.

For example, the plurality of light sources 111 may be disposed in rows and columns. Accordingly, a plurality of light sources may be disposed so that that a substantially square may be formed by four adjacent light sources. Further, any one light source may be disposed adjacent to the four light sources, and distances between the one light source and the four light sources adjacent thereto may be approximately the same.

As another example, the plurality of light sources may be disposed in a plurality of rows, and a light source belonging to each row may be disposed at a center between two light sources belonging to adjacent rows. Accordingly, the plurality of light sources may be disposed so that an approximately equilateral triangle may be formed by three adjacent light sources. In this case, one light source may be disposed adjacent to six light sources, and distances between the one light source and the six light sources adjacent thereto may be approximately the same.

However, the pattern in which the plurality of light sources 111 are disposed is not limited to the above-described pattern, and the plurality of light sources 111 may be disposed in various patterns so that light may be emitted with uniform luminance.

The light source 111 may employ an element capable of emitting monochromatic light (light of a specific wavelength such as, for example, blue light) or white light (e.g., a mixture of red light, green light, and blue light) in various directions when power is supplied. For example, the light source 111 may include a light-emitting diode (LED).

The substrate 112 may fix the plurality of light sources 111 so that positions of the light sources 111 are not changed. Further, the substrate 112 may supply power for emitting light by the light sources 111 to each light source 111.

The substrate 112 may be composed of a synthetic resin or tempered glass or a printed circuit board (PCB) formed with a conductive power feeding line configured to fix the plurality of light sources 111 and supply the power to the light sources 111.

The reflective sheet 120 may reflect the light emitted from the plurality of light sources 111 in a frontward direction or in a direction close to the frontward direction.

A plurality of through holes 120a may be formed in the reflective sheet 120 at positions respectively corresponding to the plurality of light sources 111 of the light source module 110. Further, the light sources 111 of the light source module 110 may pass through the through holes 120a and protrude in front of the reflective sheet 120.

For example, during the assembly process of the reflective sheet 120 and the light source module 110, the plurality of light sources 111 of the light source module 110 may be inserted into the plurality of holes 120a (e.g., through-holes) formed in the reflective sheet 120. Accordingly, although the substrate 112 of the light source module 110 is located at the rear of the reflective sheet 120, the plurality of light sources 111 of the light source module 110 may be located in front of the reflective sheet 120.

With this structure, the plurality of light sources 111 may emit light from the front of the reflective sheet 120.

The plurality of light sources 111 may emit light in various directions in front of the reflective sheet 120. The light may be emitted toward the diffuser plate 130 from the light sources 111 as well as toward the reflective sheet 120 from the light sources 111, and the reflective sheet 120 may reflect the light emitted toward the reflective sheet 120 toward the diffuser plate 130.

The light emitted from the light sources 111 may pass through various objects such as the diffuser plate 130, the optical sheet 140, and the like. When the light passes through the diffuser plate 130 and the optical sheet 140, some of the incident light is reflected from the surfaces of the diffuser plate 130 and the optical sheet 140. The reflective sheet 120 may reflect the light reflected by the diffuser plate 130 and the optical sheet 140.

The diffuser plate 130 may be provided in front of the light source module 110 and the reflective sheet 120, and may uniformly distribute the light emitted from the light sources 111 of the light source module 110.

The diffuser plate 130 may diffuse the light emitted from the plurality of light sources 111 in the diffuser plate 130 to remove the luminance non-uniformity caused by the plurality of light sources 111 arranged to be spaced apart from each other. In other words, the diffuser plate 130 may uniformly emit the non-uniform light from the plurality of light sources 111 to the front.

The optical sheet 140 may include various sheets for improving luminance and luminance uniformity. For example, the optical sheet 140 may include a diffuser sheet 141, a first prism sheet 142, a second prism sheet 143, a reflective polarization sheet 144, and the like. However, embodiments of the disclosure are not limited thereto. The optical sheet 140 may include at least one from among the diffuser sheet 141, the first prism sheet 142, the second prism sheet 143, and the reflective polarization sheet 144.

The diffuser sheet 141 may diffuse light for luminance uniformity. The light emitted from the light source 111 may be diffused by the diffuser plate 130 and may be diffused again by the diffuser sheet 141 included in the optical sheet 140.

The first prism sheet 142 and the second prism sheet 143 may increase luminance by focusing the light diffused by the diffuser sheet 141. The first prism sheet 142 and second prism sheet 143 may include a prism pattern having a triangular prism shape, and a plurality of the prism patterns may be arranged to be adjacent to each other to form a plurality of bands.

The reflective polarization sheet 144 may be a type of polarization film, and may transmit some of the incident light to improve luminance and reflect the remaining light.

For example, polarized light in the same direction as a predetermined polarization direction of the reflective polarization sheet 144 may be transmitted, and polarized light in a direction different from the polarization direction of the reflective polarization sheet 144 may be reflected. Further, the light reflected by the reflective polarization sheet 144 may be recycled in the backlight unit 100, and the luminance of the display apparatus 10 may be improved by such light recycling.

The optical sheet 140 is not limited to the sheet(s) or film(s) shown in FIG. 4, and may include more various sheets or films, such as a protection sheet and the like.

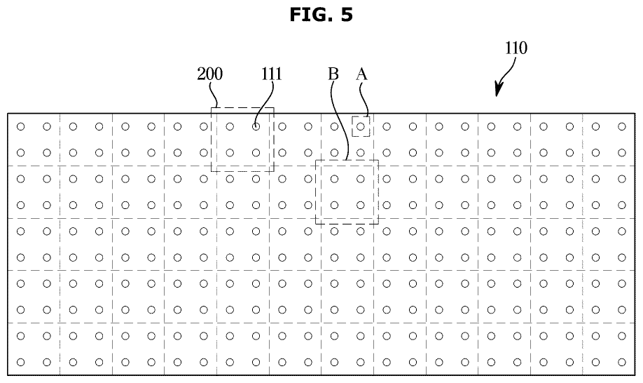

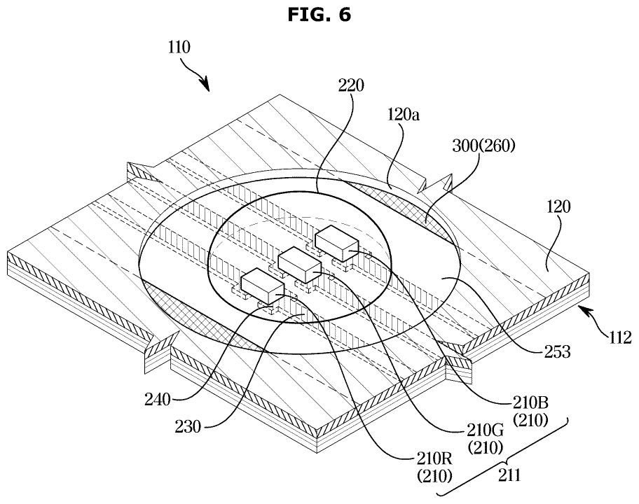

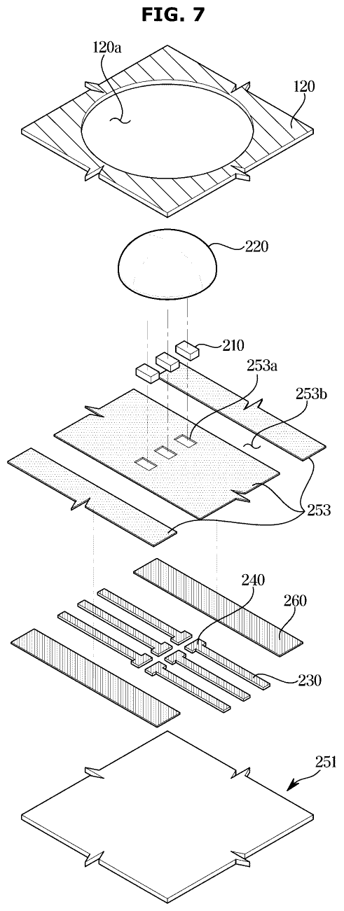

FIG. 5 is a plan view of a light source module for explaining the concept of a dimming block in the backlight unit according to an embodiment. FIG. 6 is a perspective view showing an enlarged view of a part A of FIG. 5. FIG. 7 is an exploded view of the light source shown in FIG. 6.

A display apparatus 10 according to an embodiment of the disclosure may perform local dimming that varies the brightness of light in respective regions of a backlight unit 100 in association with an output image so as to improve contrast ratio while reducing power consumption.

For example, the display apparatus 10 may reduce the brightness of light emitted from light sources 111 of the backlight unit 100 corresponding to a dark portion of an image in order to make the dark portion darker. The display apparatus 10 may increase the brightness of light emitted from the light sources 111 of the backlight unit 100 corresponding to a bright portion of the image in order to make the bright portion brighter. Accordingly, the contrast ratio of the image may be improved.

The display apparatus 10 may divide the light sources 111 of the backlight unit 100 into a plurality of blocks and control the current supplied to each of the blocks independently in order to perform the above-described local dimming. Hereinafter, each of the above-described plurality of blocks may be referred to as a dimming block 200. The display apparatus 10 may independently adjust the current supplied to each dimming block 200 according to an input image.

The display apparatus 10 may improve the contrast ratio effectively by decreasing the current supplied to a dimming block 200 corresponding to a dark area of the input image and increasing the current supplied to a dimming block 200 corresponding to a bright area of the input image.

As described above, the plurality of light sources 111 included in the backlight unit 100 may be divided into a plurality of dimming blocks 200. The plurality of dimming blocks 200 may be arranged in a matrix form on a substrate 112. For example, as shown in FIG. 5, a total of 60 dimming blocks 200 may be arranged in five rows and twelve columns. However, the number of dimming blocks 200 and the numbers of rows and columns are not limited thereto.

The backlight unit 100 may include the plurality of dimming blocks 200, and each of the plurality of dimming blocks 200 may include at least one light source 111. The backlight unit 100 may supply the same driving current to the light sources 111 belonging to the same dimming block 200. The light sources 111 belonging to the same dimming block 200 and supplied with the same driving current may emit light having the same brightness. However, as will be described later, in a case where one light source 111 includes a red light emitting diode 210R, a green light emitting diode 210G, and a blue light emitting diode 210B, red light emitting diodes 210R connected in series within the same dimming block 200 may emit light having the same brightness, green light emitting diodes 210G connected in series may emit light having the same brightness, and blue light emitting diodes 210B connected in series may emit light having the same brightness.

The backlight unit 100 may supply different driving currents to light sources 111 belonging to different dimming blocks 200 according to dimming data. The light sources 111 belonging to different dimming blocks 200 may emit light having different brightness levels. In other words, when a first dimming block and a second dimming block are supplied with different driving currents, the light sources belonging to the first dimming block and the light sources belonging to the second dimming block may emit light having different brightness levels. However, as will be described later, in a case where one light source 111 includes a red light emitting diode 210R, a green light emitting diode 210G, and a blue light emitting diode 210B, the red light emitting diodes 210R belonging to the first dimming block and the red light emitting diodes 210R belonging to the second dimming block may emit light having different brightness levels from each other; the green light emitting diodes 210G belonging to the first dimming block and the green light emitting diodes 210G belonging to the second dimming block may emit light having different brightness levels from each other; and the blue light emitting diodes 210B belonging to the first dimming block and the blue light emitting diodes 210B belonging to the second dimming block may emit light having different brightness levels from each other.

Referring to FIG. 5, each of the plurality of dimming blocks 200 may include MxN light sources 111 arranged in an M×N matrix form (where M and N are natural numbers). The M×N matrix means a matrix having M rows and N columns. According to an embodiment, each of the plurality of dimming blocks 200 may include four light sources 111 arranged in a 2×2 matrix form. The four light sources 111 forming one dimming block 200 may be configured to be turned on or off simultaneously.

Referring to FIGS. 4 to 6, the light source module 110 may include a plurality of light sources 111. Each of the plurality of light sources 111 may protrude to the front of the reflective sheet 120 by passing through a through hole 120a from the rear of the reflective sheet 120. Accordingly, as shown in FIG. 6, the light source 111 and a portion of the substrate 112 may be exposed toward the front of the reflective sheet 120 through the through hole 120a.

Each light source 111 may include an electrical/mechanical structure disposed in a region defined by the through hole 120a of the reflective sheet 120.

Each of the plurality of light sources 111 may include at least one light emitting diode 210 and an optical dome 220 configured to cover the at least one light emitting diode 210.

According to an embodiment, each light source 111 may include three light emitting diodes 210 and one optical dome 220 configured to cover the three light emitting diodes. In other words, the optical dome 220 may accommodate three light emitting diodes 210 therein. However, embodiments of the disclosure are not limited thereto. Each light source may include two light emitting diodes and one optical dome configured to cover the two light emitting diodes. Each light source may include one light emitting diode and one optical dome configured to cover the one light emitting diode.

Each light source 111 may include one light emitting diode group 211. The light emitting diode group 211 may refer to three light emitting diodes (e.g., a red light emitting diode 210R, a green light emitting diode 210G, and a blue light emitting diode 210B) that are covered by one optical dome 220. One light emitting diode group 211 may include a red light emitting diode 210R configured to emit red light, a green light emitting diode 210G configured to emit green light, and a blue light emitting diode 210B configured to emit blue light. Each light source 111 may include one light emitting diode group 211 and one optical dome 220 configured to cover the same.

As described above, each of the plurality of dimming blocks 200 may include four light sources 111 arranged in a 2×2 matrix form. Each dimming block 200 may include four light emitting diode groups 211 configured to be turned on or off simultaneously. The light emitting diodes of the four light emitting diode groups 211 may be connected in series with each other. Specifically, the red light emitting diodes 210R of the four light emitting diode groups 211 may be connected in series with each other. The green light emitting diodes 210G of the four light emitting diode groups 211 may be connected in series with each other. The blue light emitting diodes 210B of the four light emitting diode groups 211 may be connected in series with each other.

The light emitting diode 210 may include a P-type semiconductor and an N-type semiconductor for emitting light through recombination of holes and electrons. In addition, the light emitting diode 210 may be provided with a pair of electrodes configured to supply holes and electrons to the P-type and N-type semiconductors, respectively.

The light emitting diode 210 may convert electrical energy into optical energy. In other words, the light emitting diode 210 may emit light having a peak intensity at a predetermined wavelength when power is supplied. For example, the blue light emitting diode 210B may emit blue light having a peak wavelength in a blue range (e.g., between 450 nm and 495 nm).

The light emitting diode 210 may be directly mounted on the substrate 112 in a chip-on-board (COB) manner. In other words, the light source 111 may include the light emitting diode 210 in which a light emitting diode chip or a light emitting diode die is directly attached to the substrate 112 without a separate package.

In order to improve the uniformity of surface light emitted by the backlight unit 100 and to enhance the contrast ratio by local dimming, the number of light sources 111 may be increased. As a result, the area that may be occupied by each of the plurality of light sources 111 may be reduced.

To reduce the area occupied by each of the plurality of light sources 111, the light source 111 may omit an antistatic circuit (e.g., a Zener diode) for preventing or suppressing damage to the light emitting diode 210 caused by electrostatic discharge. In other words, the light source 111 may not include a Zener diode connected in parallel to the light emitting diode 210.

In order to reduce the area occupied by the light emitting diode 210, the light emitting diode 210 may be implemented in a flip chip type that does not include a Zener diode. A light emitting diode 210 (e.g., a flip chip type light emitting diode) may directly bond the electrode pattern of the semiconductor element to the substrate 112 without using an intermediate medium such as a metal lead (wire) or a ball grid array (BGA) when attaching the light emitting diode as a semiconductor device to the substrate 112.

As such, by omitting the metal lead or ball grid array, a light source 111 including the light emitting diode 210 (e.g., the flip chip type light emitting diode) may be miniaturized.

To achieve the miniaturization of the light source 111, a light source module 110 may be manufactured in which the type light emitting diode 210 (e.g., the flip chip type light emitting diode) is mounted on the substrate 112 in a chip-on-board manner.

The substrate 112 may be provided with a power feeding line 230 and a power feeding pad 240 for supplying power to the light emitting diode 210 (e.g., the flip chip type light emitting diode).

The substrate 112 may be provided with a power feeding line 230 configured to supply an electric signal and/or power from a control assembly 50 and/or a power supply assembly (e.g., a power assembly 60) to the light emitting diode 210.

The substrate 112 may be formed by alternately stacking at least one insulating layer 251 (e.g., a non-conductive insulating layer) and at least one conductive layer 252.

The conductive layer 252 may include a line or pattern through which power and/or an electric signal flows. The conductive layer 252 may be formed of various materials having electrical conductivity. For example, the conductive layer 252 may be made of various metal materials such as copper (Cu), tin (Sn), aluminum (Al), or an alloy thereof.

A dielectric material of the insulating layer 251 may insulate between lines or patterns of the conductive layer 252. The insulating layer 251 may be formed of a dielectric material for electrical insulation, such as FR-4.

The substrate 112 may be provided with a protective layer 253 configured to prevent or suppress damage caused by external impact and/or chemical action (e.g., corrosion) and/or optical action.

The protective layer 253 may be configured to cover the first surface of the substrate 112 on which the light emitting diode 210 is mounted. The protective layer 253 may include a photo solder resist (PSR). The protective layer 253 may be formed by applying liquid photo solder resist (PSR) onto the substrate 112 and curing it. The protective layer 253 may include at least one first window 253a and at least one second window 253b (see FIG. 7). Hereinafter, the first surface of the substrate 112 may refer to the mounting surface of the substrate 112. Based on FIGS. 6 and 7, the first surface of the substrate 112 may be an upper surface of the substrate 112, and the second surface of the substrate 112 may be a lower surface of the substrate 112.

The power feeding line 230 may be implemented by a line or pattern formed in the conductive layer 252. The power feeding line 230 may be a portion of the conductive layer 252 stacked on the insulation layer 251.

The power feeding pad 240, which may be a part of the conductive layer 252 stacked on the insulation layer 251, may be provided to be in contact with the light emitting diode 210. The power feeding pad 240 may be connected to the power feeding line 230. The power feeding pad 240 may be connected to one end of the power feeding line 230. The power feeding pad 240 may be at one end of the power feeding line 230.

The power feeding line 230 may be electrically connected to the light emitting diode 210 through the power feeding pad 240. At least a portion of the power feeding pad 240 may be exposed to the outside through a first window 253a formed in the protective layer 253. The power feeding pad 240 and the light emitting diode 210 may be electrically connected through the at least a portion of the power feeding pad 240 exposed through the first window 253a.

The protective layer 253 may cover the power feeding line 230 so as to prevent the power feeding line 230 from being exposed to the outside. The protective layer 253 may cover a remaining portion of the power feeding pad 240 other than the at least a portion of the power feeding pad 240 exposed through the first window 253a, so as to prevent the remaining portion of the power feeding pad 240 from being exposed to the outside. In other words, at least a portion of the power feeding pad 240 may be exposed to the outside through the first window 253a and the protective layer 253 may cover the remaining portion of the power feeding pad 240 and the power feeding line 230.

A conductive adhesive material may be applied to the at least a portion of the power feeding pad 240 exposed through the first window 253a to provide electrical contact between an electrode of the light emitting diode 210 and the power feeding pad 240. The conductive adhesive material may be applied to the power feeding pad 240 through the first window 253a of the protective layer 253.

An electrode of the light emitting diode 210 may be in contact with the conductive adhesive material, and the light emitting diode 210 may be electrically connected to the power feeding line 230 through the conductive adhesive material. For example, the conductive adhesive material may include a solder having electrical conductivity. However, the conductive adhesive material is not limited thereto and may include electrically conductive epoxy adhesives having electrical conductivity.

Power may be supplied to the light emitting diode 210 through the power feeding line 230 and the power feeding pad 240, and the light emitting diode 210 may emit light when power is supplied. A pair of power feeding pads 240 may be provided to correspond to a pair of electrodes of the light emitting diode 210 (e.g., a flip chip type light emitting diode).

The optical dome 220 may be configured to cover at least one light emitting diode 210. According to an embodiment, the optical dome 220 may be configured to cover one light emitting diode group 211. The light emitting diode group 211 may include a red light emitting diode 210R, a green light emitting diode 210G, and a blue light emitting diode 210B. The optical dome 220 may be provided to cover the red light emitting diode 210R, the green light emitting diode 210G, and the blue light emitting diode 210B.

The optical dome 220 may prevent or suppress damage to the light emitting diode 210 caused by external mechanical actions and/or chemical actions. The optical dome 220 may also prevent or suppress damage to the light emitting diode group 211 caused by external mechanical actions and/or chemical actions.

According to an embodiment, the optical dome 220 may have a dome shape formed by cutting a sphere with a plane not passing through the center, or may have a hemispherical shape formed by cutting a sphere with a plane including the center. A vertical cross section of the optical dome 220 may be, for example, arcuate or semicircular.

The optical dome 220 may be formed of silicone or epoxy resin. For example, molten silicone or epoxy resin may be discharged onto the light emitting diode 210 through a nozzle or the like, and the discharged silicone or epoxy resin may be cured to form the optical dome 220.

Accordingly, the shape of the optical dome 220 may vary depending on the viscosity of the liquid silicone or epoxy resin. For example, when the optical dome 220 is formed using silicone having a thixotropic index of approximately 2.7 to 3.3 (e.g., 3.0), a dome ratio (height of the dome/diameter of the base of the dome) of approximately 2.5 to 3.1 (e.g., 2.8) may be achieved. For instance, the optical dome 220 formed using silicone having a thixotropic index of approximately 2.7 to 3.3 (e.g., 3.0) may have a base diameter of approximately 2.5 mm and a height of approximately 0.7 mm.

The optical dome 220 may be optically transparent or translucent. Light emitted from the light emitting diode 210 may pass through the optical dome 220 and be emitted to the outside.

The optical dome 220, which may be domed-shaped, may refract light like a lens. For example, light emitted from the light emitting diode 210 may be refracted by the optical dome 220 and thereby diffused.

As such, the optical dome 220 may not only protect the light emitting diode 210 from external mechanical, chemical, or electrical actions, but may also diffuse light emitted from the light emitting diode 210.

The backlight unit 100 may include an antistatic member 260. The antistatic member 260 may be implemented by a wiring or pattern formed in the conductive layer 252. In other words, the antistatic member 260 may be a portion of the conductive layer 252 stacked on the insulation layer 251. The antistatic member 260 may be spaced apart from the power feeding pad 240 and the power feeding line 230 so as not to be connected (e.g., electrically connected) thereto.

The protective layer 253 may cover at least a portion of the antistatic member 260 to prevent it from being exposed to the outside. A portion of the antistatic member 260 may be exposed to the outside through a second window 253b of the protective layer 253. The portion of the antistatic member 260 exposed through the second window 253b may capture current generated by electrostatic discharge.

Referring to FIGS. 6 and 7, a portion of the antistatic member 260 not covered by the protective layer 253 may be an antistatic pad 300. In other words, the portion of the antistatic member 260 exposed to the outside through the second window 253b of the protective layer 253 may be the antistatic pad 300.

The antistatic member 260 may include a portion covered by the protective layer 253 and a portion not covered by the protective layer 253 and exposed to the outside, i.e., the antistatic pad 300. However, at least a portion of the antistatic pad 300 exposed through the protective layer 253 may be covered by the reflective sheet 120.

According to an embodiment, the antistatic member 260 may be provided near the optical dome 220 and the power feeding line 230 to protect the light emitting diode 210 from electrostatic discharge. More specifically, the antistatic pad 300 may be provided near the optical dome 220 and the power feeding line 230 to protect the light emitting diode 210 from electrostatic discharge. The antistatic pad 300 may absorb electrical shocks caused by electrostatic discharge occurring near the optical dome 220 and the power feeding line 230.

The optical dome 220 may protect the light emitting diode 210 from external electrical actions. The optical dome 220 may prevent charges generated by electrostatic discharge from passing through the optical dome 220. The optical dome 220 may guide the charge to flow along the outer surface of the optical dome 220. In a comparative embodiment, charge flowing along the outer surface of an optical dome may reach a light emitting diode along the boundary between the optical dome and the substrate. The light emitting diode may be damaged due to an electrical shock caused by the charge penetrating along the boundary between the optical dome and the substrate. To prevent or suppress such current flow, that is, the flow of charge, the antistatic pad 300 may be provided near the optical dome 220.

The antistatic member 260 may provide a path for current caused by electrostatic discharge generated near the optical dome 220 and the power feeding line 230. In other words, the antistatic member 260 may guide the charge caused by electrostatic discharge to flow toward the ground.

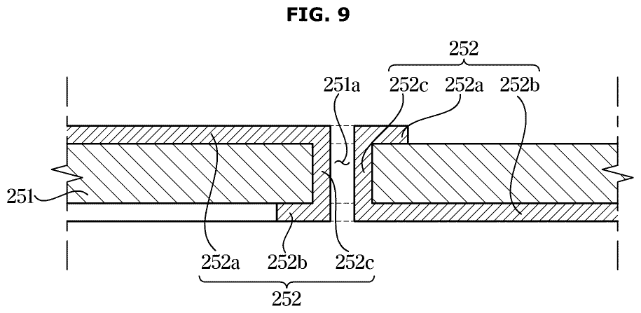

Referring to FIGS. 6 and 7, the substrate 112 may be arranged in parallel with the reflective sheet 120 such that a first surface of the substrate 112 faces the reflective sheet 120. The substrate 112 may include an insulation layer 251 and a conductive layer 252 stacked on the insulation layer 251. A portion of the first surface of the substrate 112 may be the insulation layer 251, and the remaining portion of the first surface may be the conductive layer 252. In other words, the insulation layer 251 may be a partial region of the first surface, and similarly, the conductive layer 252 may be another partial region of the first surface. At least a portion of a second surface of substrate 112, opposite of the first surface, may be a portion of the conductive layer 252. In this case, with reference to FIG. 9, the conductive layer defining at least a portion of the first surface may be referred to as a first conductive layer 252a, and the conductive layer defining at least a portion of the second surface may be a second conductive layer 252b, which will be described below.

The power feeding pad 240 may be a part of the conductive layer 252. The power feeding line 230 may also be a part of the conductive layer 252. The antistatic member 260 may be a part of the conductive layer 252. In other words, the conductive layer 252 may include the power feeding pad 240, the power feeding line 230, and the antistatic member 260. The conductive layer 252 may include the power feeding pad 240 and the power feeding line 230 connected (e.g., electrically connected) to each other, and the antistatic member 260 spaced apart from and not connected (e.g., electrically connected) to the power feeding pad 240 and the power feeding line 230.

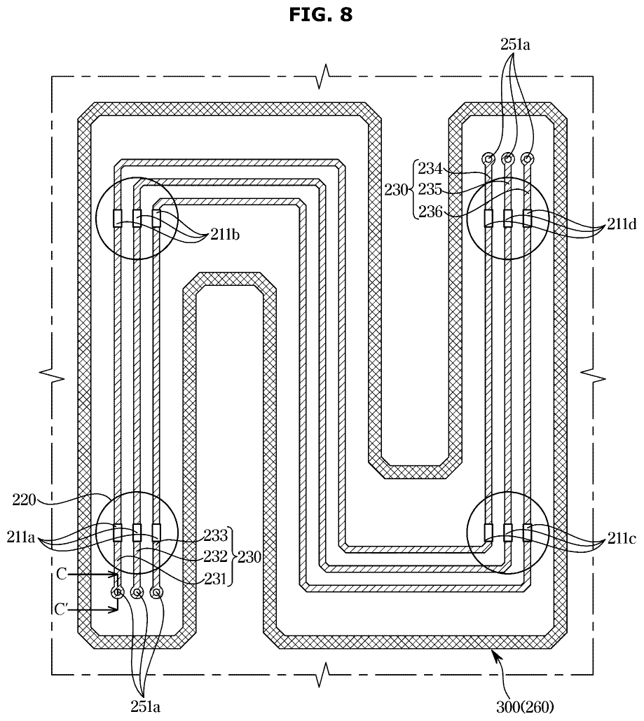

FIG. 8 is an enlarged view of a part B of FIG. 5 and illustrates an example of a dimming block of a backlight unit according to an embodiment. FIG. 9 is a cross-sectional view taken along a line C-C′ of FIG. 8.

The antistatic pad 300 may be provided near the power feeding line 230 to protect the light emitting diode 210 connected to the power feeding line 230 from electrostatic discharge. As described above, since one optical dome 220 covers three light emitting diodes (e.g., the red light emitting diode 210R, the green light emitting diode 210G, and the blue light emitting diode 210B), the width of the power feeding line 230 connected to each light emitting diode may be reduced. When the width of a power feeding line becomes narrow, the current density flowing through the power feeding line may increase. When current caused by electrostatic discharge flows through a power feeding line having a narrow width, an excessively large current may be transmitted through the power feeding line to the light emitting diode in a comparative embodiment, which may damage the light emitting diode.

To prevent damage to the light emitting diode 210 caused by electrostatic discharge, the backlight unit 100 according to an embodiment of the disclosure may include an antistatic pad 300 having a closed curve shape in which at least one optical dome 220 and at least a portion of the power feeding line 230 are disposed.

The antistatic pad 300 may be provided to surround one or more optical domes 220 and at least a portion of the power feeding line 230 connected to at least one light emitting diode 210 covered by each of the one or more optical domes 220. In other words, the antistatic pad 300 may form a closed curve, as a part of the first surface of the substrate 112, in which the optical dome 220 and at least a portion of the power feeding line 230 connected to the light emitting diode 210 inside the optical dome 220 are disposed. The antistatic pad 300 may also form a closed curve, as a part of the first surface of the substrate 112, in which a plurality of optical domes 220 and at least a portion of the power feeding lines connected to the light emitting diodes 210 inside the plurality of optical domes 220 are disposed.

As described above, by providing the antistatic pad 300 continuously around the optical dome 220 and the power feeding line 230, damage to the light emitting diode 210 can be prevented even when electrostatic discharge occurs near the optical dome 220 and the power feeding line 230. That is, since the antistatic pad 300 is arranged close to the optical dome 220 and the power feeding line 230 in all directions, current generated by electrostatic discharge may flow through the antistatic pad 300 instead of flowing through the power feeding line 230. The current flowing through the antistatic pad 300 may be discharged through the antistatic member 260, which includes the antistatic pad 300, and a ground connected to the antistatic member 260.

Referring to FIG. 8, a dimming block 200 according to an embodiment may include four light emitting diode groups 211a, 211b, 211c, and 211d that are connected to be turned on or off simultaneously. The dimming block 200 may include four red light emitting diodes 210R connected in series with each other. The dimming block 200 may include four green light emitting diodes 210G connected in series with each other. The dimming block 200 may include four blue light emitting diodes 210B connected in series with each other. Accordingly, the dimming block 200 may include a total of twelve light emitting diodes 210 and four optical domes 220 configured to cover the respective light emitting diode groups.

As shown in FIG. 8, an antistatic pad 300 according to an embodiment may form a closed curve in which the dimming block 200 is disposed. The antistatic pad 300 may form a closed curve as a part of the first surface of the substrate 112. Inside the closed curve formed by the antistatic pad 300, the four light emitting diode groups 211a, 211b, 211c, and 211d may be disposed. At least a portion of a plurality of power feeding lines 230 configured to connect the light emitting diodes in the four light emitting diode groups 211a, 211b, 211c, and 211d to each other may also be disposed inside the closed curve.

Inside the closed curve formed by the antistatic pad 300, a first end 231 and a second end 234 of a first power feeding line configured to connect the four red light emitting diodes in series may be disposed. The first end 231 of the first power feeding line may be connected to a via hole 251a of the substrate 112. The second end 234 of the first power feeding line may also be connected to a via hole 251a of the substrate 112. The first end 231 and the second end 234 may be connected to the second surface of the substrate 112 through the via holes 251a. One from among the first end 231 and the second end 234 connected to the second surface of the substrate 112 may be connected to a pixel IC configured to control local dimming. The other one from among the first end 231 and the second end 234 may be connected to a power feeding line that connects other light emitting diodes on the second surface of the substrate 112.

Inside the closed curve formed by the antistatic pad 300, a first end 232 and a second end 235 of a second power feeding line configured to connect the four green light emitting diodes in series may be disposed. The first end 232 and the second end 235 of the second power feeding line may each be connected to a via hole 251a of the substrate 112. The first end 232 and the second end 235 may be connected to the second surface of the substrate 112 through the via holes 251a. One from among the first end 232 and the second end 235 connected to the second surface of the substrate 112 may be connected to a pixel IC configured to control local dimming. The other one from among the first end 232 and the second end 235 may be connected to a power feeding line that connects other light emitting diodes on the second surface of the substrate 112.

Inside the closed curve formed by the antistatic pad 300, a first end 233 and a second end 236 of a third power feeding line configured to connect the four blue light emitting diodes in series may be disposed. The first end 233 and the second end 236 of the third power feeding line may each be connected to a via hole 251a of the substrate 112. The first end 233 and the second end 236 may be connected to the second surface of the substrate 112 through the via holes 251a. One from among the first end 233 and the second end 236 connected to the second surface of the substrate 112 may be connected to a pixel IC configured to control local dimming. The other from among the first end 233 and the second end 236 may be connected to a power feeding line that connects other light emitting diodes on the second surface of the substrate 112.

Referring to FIG. 9, the substrate 112 according to an embodiment may include a first conductive layer 252a and a second conductive layer 252b. The substrate 112 may include at least one via hole 251a passing therethrough from a first surface to a second surface of the substrate 112. At least a portion of the first conductive layer 252a may be connected to the second conductive layer 252b through the via hole 251a. In this case, a connection portion 252c configured to connect the first conductive layer 252a and the second conductive layer 252b may be provided inside the via hole 251a. The first conductive layer 252a, the second conductive layer 252b, and the connection portion 252c may be formed of various electrically conductive materials. For example, they may be formed of copper (Cu), tin (Sn), aluminum (Al), or an alloy thereof.

As described above, when the first conductive layer 252a provided on the first surface of the substrate 112 and the second conductive layer 252b provided on the second surface of the substrate 112 are connected through the via hole 251a, the structure may be referred to as a double-sided PCB or a double-sided substrate.

According to an embodiment, the substrate 112 may be implemented as a double-sided substrate, and at least a portion of the power feeding line 230 disposed inside the closed curve formed by the antistatic pad 300 may be connected from the first surface to the second surface of the substrate 112 through the via hole 251a.

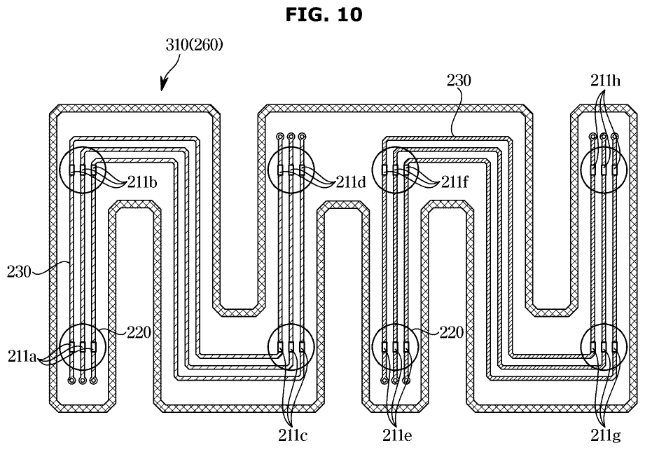

FIG. 10 is a plan view showing two adjacent dimming blocks among a plurality of dimming blocks in a backlight unit according to an embodiment.

Referring to FIG. 10, the backlight unit 100 according to an embodiment may include an antistatic pad 310 configured to surround two adjacent dimming blocks among the plurality of dimming blocks 200.

The antistatic pad 310 according to an embodiment may form a closed curve in which two dimming blocks are disposed. However, embodiments of the disclosure are not limited thereto. The antistatic pad 310 may form a closed curve in which three or more dimming blocks are disposed.

Each of the dimming blocks may include four light emitting diode groups. Accordingly, the antistatic pad 310 may be configured to surround a total of eight light emitting diode groups 211a, 211b, 211c, 211d, 211e, 211f, 211g, and 211h. In other words, the antistatic pad 310 may form a closed curve in which the eight light emitting diode groups 211a, 211b, 211c, 211d, 211e, 211f, 211g, and 211h are disposed.

As shown in FIG. 10, a first end and a second end of the power feeding line 230 configured to connect the four light emitting diode groups included in each of the dimming blocks may be disposed inside the antistatic pad 310.

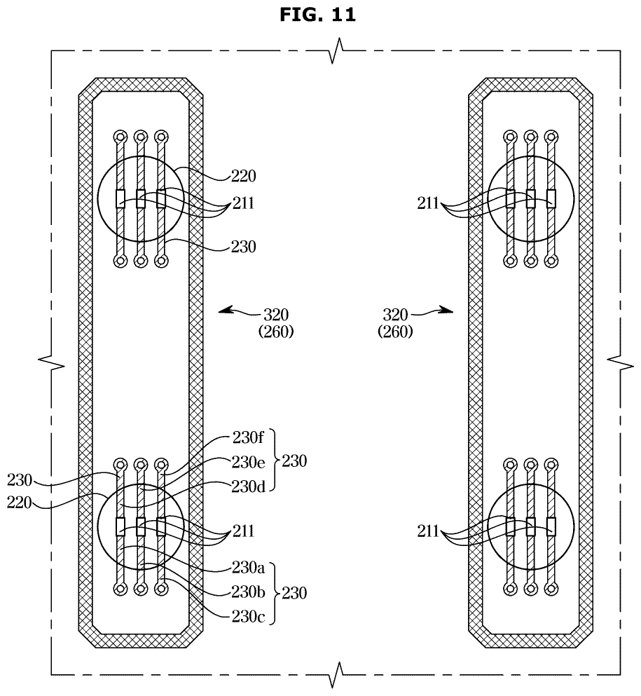

FIG. 11 illustrates some of the light emitting diodes among a plurality of light emitting diodes in a backlight unit according to an embodiment.

An antistatic pad 320 according to an embodiment may be configured to surround at least two light emitting diode groups. The antistatic pad 320 may form a closed curve in which the at least two light emitting diode groups are disposed.

Referring to FIG. 11, the antistatic pad 320 may be configured to surround two adjacent light emitting diode groups 211. The antistatic pad 320 may form a closed curve in which a first light emitting diode group 211 and a second light emitting diode group 211 adjacent to each other are disposed.

Inside the closed curve formed by the antistatic pad 320, a first end 230a and a second end 230d of a power feeding line connected to the red light emitting diode of the first light emitting diode group 211 may be disposed. Inside the closed curve, a first end and a second end of a power feeding line connected to the red light emitting diode of the second light emitting diode group 211 may also be disposed.

Inside the closed curve formed by the antistatic pad 320, a first end 230b and a second end 230e of a power feeding line connected to the green light emitting diode of the first light emitting diode group 211 may be disposed. Inside the closed curve, a first end and a second end of a power feeding line connected to the green light emitting diode of the second light emitting diode group 211 may also be disposed.

Inside the closed curve, a first end 230c and a second end 230f of a power feeding line connected to the blue light emitting diode of the first light emitting diode group 211 may be disposed. Inside the closed curve, a first end and a second end of a power feeding line connected to the blue light emitting diode of the second light emitting diode group 211 may also be disposed.

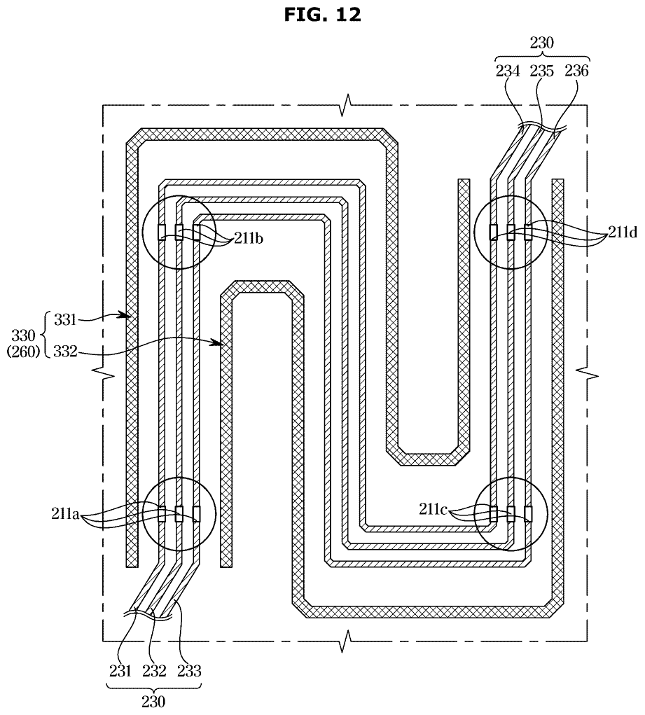

FIG. 12 illustrates an example of a dimming block in a backlight unit according to an embodiment.

Referring to FIG. 12, in the backlight unit 100 according to an embodiment, an antistatic pad 330 may include a pair of antistatic lines (e.g., a first antistatic line 331 and a second antistatic line 332) extending from one end to the other end of the dimming block 200.

The antistatic line may refer to a portion of the antistatic member 260 that is not covered by the protective layer 253, similarly to the antistatic pad. Hereinafter, since the antistatic line has a line shape like the power feeding line 230, it will be referred to as an antistatic line instead of an antistatic pad.

According to an embodiment, the antistatic pad 330 may include a first antistatic line 331 extending from one end to the other end of the dimming block 200, and a second antistatic line 332 spaced apart from the first antistatic line 331 and also extending from one end to the other end of the dimming block 200.

The first antistatic line 331 may extend from one side of the first light emitting diode group 211a, which forms one end of the dimming block 200, along the power feeding line 230 to one side of the fourth light emitting diode group 211d, which forms the other end of the dimming block 200. The one side of the first light emitting diode group 211a may be the left side of the first light emitting diode group 211a based on FIG. 12.

The second antistatic line 332 may extend from the other side of the first light emitting diode group 211a, which forms the one end of the dimming block 200, along the power feeding line 230 to the other side of the fourth light emitting diode group 211d, which forms the other end of the dimming block 200. The other side of the first light emitting diode group 211a may be the right side of the first light emitting diode group 211a based on FIG. 12.

The first antistatic line 331 and the second antistatic line 332 may be spaced apart from each other. Between the first antistatic line 331 and the second antistatic line 332 spaced apart from each other, the first light emitting diode group 211a, the second light emitting diode group 211b, the third light emitting diode group 211c, the fourth light emitting diode group 211d, and a power feeding line 230 connecting the first light emitting diode group 211a, the second light emitting diode group 211b, the third light emitting diode group 211c, and the fourth light emitting diode group 211d may be disposed.

As illustrated in FIG. 12, a first end 231 of a first power feeding line connected to the first light emitting diode group 211a forming the one end of the dimming block 200 may extend outside the dimming block 200 through a space between the first antistatic line 331 and the second antistatic line 332. Likewise, a first end 232 of a second power feeding line connected to the first light emitting diode group 211a forming the one end of the dimming block 200 may extend outside the dimming block 200 through a space between the first antistatic line 331 and the second antistatic line 332. A first end 233 of a third power feeding line connected to the first light emitting diode group 211a forming the one end of the dimming block 200 may also extend outside the dimming block 200 through a space between the first antistatic line 331 and the second antistatic line 332.

As illustrated in FIG. 12, a second end 234 of the first power feeding line connected to the fourth light emitting diode group 211d forming the other end of the dimming block 200 may extend outside the dimming block 200 through a space between the first antistatic line 331 and the second antistatic line 332. Likewise, a second end 235 of the second power feeding line connected to the fourth light emitting diode group 211d forming the other end of the dimming block 200 may extend outside the dimming block 200 through a space between the first antistatic line 331 and the second antistatic line 332. A second end 236 of the third power feeding line connected to the fourth light emitting diode group 211d forming the other end of the dimming block 200 may also extend outside the dimming block 200 through a space between the first antistatic line 331 and the second antistatic line 332.

The first end 231 or the second end 234 of the first power feeding line extending outside the dimming block 200 may be connected to a pixel IC configured to control local dimming. The first end 232 or the second end 235 of the second power feeding line extending outside the dimming block 200 may be connected to a pixel IC configured to control local dimming. The first end 233 or the second end 236 of the third power feeding line extending outside the dimming block 200 may be connected to a pixel IC configured to control local dimming.

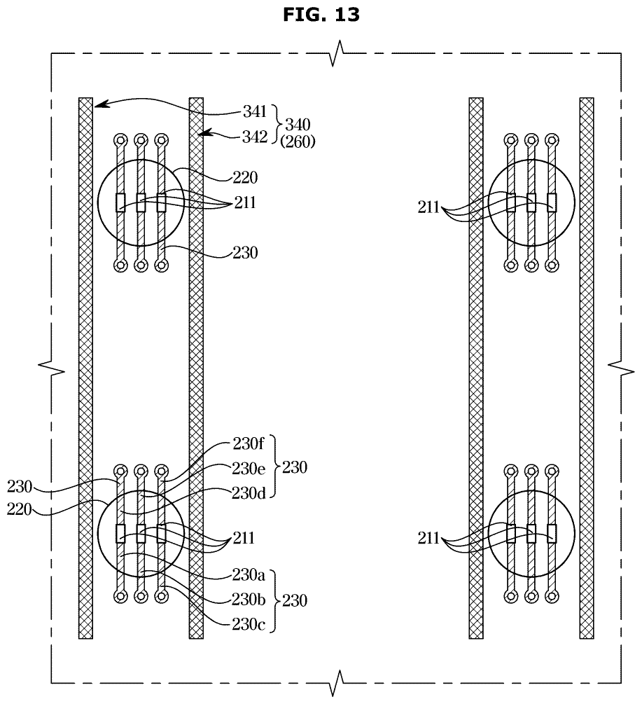

FIG. 13 illustrates some of the light emitting diodes among a plurality of light emitting diodes in a backlight unit according to an embodiment.

Referring to FIG. 13, in a backlight unit 100 according to an embodiment, an antistatic pad 340 may include a pair of antistatic lines (e.g., a first antistatic line 341 and a second antistatic line 342) extending along the power feeding line 230 on both sides of at least two light emitting diode groups.

According to an embodiment, the antistatic pad 340 may include a first antistatic line 341 extending from one side of one of two adjacent light emitting diodes to one side of the other light emitting diode along the power feeding line 230, and a second antistatic line 342 extending from the other side of the one of the two adjacent light emitting diodes to the other side of the other light emitting diode along the power feeding line 230.

The first antistatic line 341 and the second antistatic line 342 may be spaced apart from each other. Between the first antistatic line 341 and the second antistatic line 342 spaced apart from each other, the two adjacent light emitting diode groups 211 and the power feeding lines 230 connected to the two light emitting diode groups 211 may be disposed.

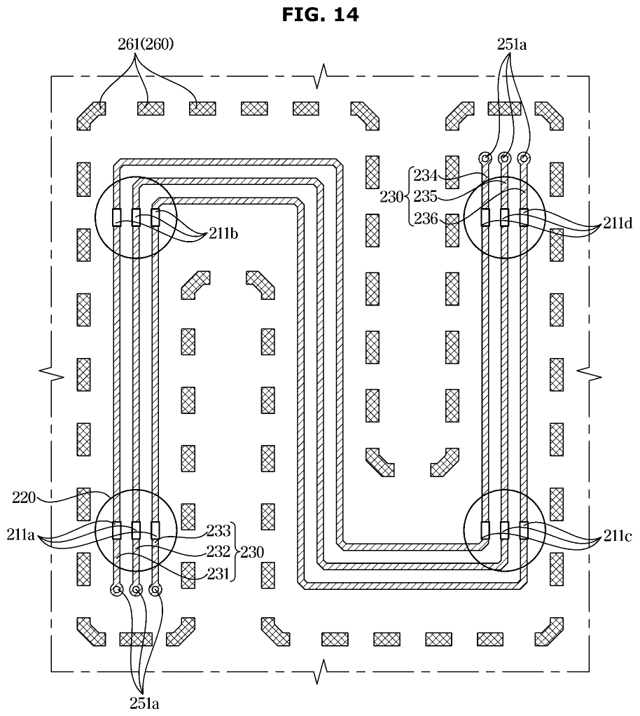

FIG. 14 illustrates an example of a dimming block in a backlight unit according to an embodiment.

Referring to FIG. 14, in a backlight unit 100 according to an embodiment, an antistatic member 260 may include a plurality of antistatic pads 261 spaced apart from one another.

As described above, the antistatic pad 261 may not be covered by the protective layer 253. Accordingly, the plurality of antistatic pads 261 may refer to portions of the antistatic member 260 exposed through the second window 253b of the protective layer 253.

According to an embodiment, the plurality of antistatic pads 261, which are spaced apart from one another, may form a dashed-line closed curve in which at least two light emitting diodes among a plurality of light emitting diodes 210 are disposed. The plurality of antistatic pads 261 may form a dashed-line closed curve in which at least two light emitting diode groups among a plurality of light emitting diode groups 211 are disposed. The plurality of antistatic pads 261 may form a dashed-line closed curve in which at least one dimming block among a plurality of dimming blocks 200 is disposed.

Referring to FIG. 14, one of the plurality of dimming blocks 200 may be disposed inside the dashed-line closed curve formed by the plurality of antistatic pads 261. Except that the closed curve is in a dashed-line form, the plurality of light emitting diode groups 211a, 211b, 211c, and 211d disposed on the inner side of the plurality of antistatic pads 261, and the first ends 231, 232, and 233 and the second ends 234, 235, and 236 of the power feeding lines are the same as those in FIG. 8, and thus repeated descriptions thereof may be omitted.

According to an aspect of the disclosure, a display apparatus may include a liquid crystal panel and backlight unit configured to provide light to the liquid crystal panel. The backlight unit may include a substrate having a first surface and a second surface opposite to the first surface, the substrate including an insulating layer forming a part of the first surface and a conductive layer forming a remaining part of the first surface, a plurality of light emitting diodes configured to be mounted on the first surface of the substrate, a power feeding pad as a part of the conductive layer, provided to be electrically connected to the plurality of light emitting diodes, a power feeding line as a part of the conductive layer, connected to the power feeding pad, and an antistatic member as a part of the conductive layer, spaced apart from the power feeding pad and the power feeding line so as not to be connected to the power feeding pad and the power feeding line. The antistatic member may form a closed curve in which at least two of the plurality of light emitting diodes are disposed.

The display apparatus may further include a dimming block including light emitting diodes among the plurality of light emitting diodes, the light emitting diodes being connected to be turned on or off simultaneously.

The antistatic member may form a closed curve in which the dimming block is disposed.

The display apparatus may further include a plurality of dimming blocks arranged in a matrix form on the first surface of the substrate, each of the plurality of dimming blocks including light emitting diodes connected to be turned on or off simultaneously.

The antistatic member may form a closed curve in which at least two adjacent dimming blocks among the plurality of dimming blocks are disposed.

The display apparatus may further include a reflective sheet having a plurality of holes and configured to cover the first surface of the substrate.

The display apparatus may further include a plurality of optical domes provided on the first surface of the substrate, each of the optical domes being disposed inside a respective one of the plurality of holes.

The display apparatus may further include a plurality of light emitting diode groups, each of the light emitting diode groups including at least two light emitting diodes among the plurality of light emitting diodes.

Each of the plurality of optical domes may be configured to cover a respective one of the plurality of light emitting diode groups.

Each of the plurality of light emitting diode groups may include a red light emitting diode, a green light emitting diode, and a blue light emitting diode.

The display apparatus may further include a dimming block including light emitting diode groups among the plurality of light emitting diode groups, the light emitting diode groups being connected to be turned on or off simultaneously.

The antistatic member may form a closed curve in which the dimming block is disposed.

The display apparatus may further include a protective layer configured to cover the first surface of the substrate, the protective layer having a first window provided to expose at least a portion of the power feeding pad and a second window provided to expose at least a portion of the antistatic member;

The antistatic member may include an antistatic pad exposed through the second window.

The antistatic pad may form a closed curve in which at least one light emitting diode among the plurality of light emitting diodes is disposed.

The conductive layer may be a first conductive layer.

The insulating layer may form a part of the second surface of the substrate.

The substrate may further include a second conductive layer forming a remaining part of the second surface.

The substrate may have a via hole formed to pass through the substrate.

A first end of the power feeding line disposed inside the closed curve may be connected to the via hole, and

The first end of the power feeding line may be connected to the second conductive layer on the second surface of the substrate through the via hole.

According to an aspect of the disclosure, a display apparatus may include a liquid crystal panel and a backlight unit configured to provide light to the liquid crystal panel. The backlight unit may include a substrate including an insulating layer forming a part of a first surface and a conductive layer forming a remaining part of the first surface, a plurality of light emitting diodes configured to be mounted on the first surface of the substrate, the plurality of light emitting diodes including a first light emitting diode and a second light emitting diode, a power feeding pad as a part of the conductive layer, provided to be in contact with the plurality of light emitting diodes, a power feeding line as a part of the conductive layer, connected to the power feeding pad and an antistatic member as a part of the conductive layer, spaced apart from the power feeding pad and the power feeding line so as not to be connected to the power feeding pad and the power feeding line. The antistatic member may extend along both sides of the power feeding line from both sides of the first light emitting diode toward both sides of the second light emitting diode.

The display apparatus may further include a dimming block including light emitting diodes among the plurality of light emitting diodes, the light emitting diodes being connected to be turned on or off simultaneously.

The antistatic member may extend along both sides of the power feeding line, which is provided to connect the light emitting diodes of the dimming block, toward both sides of the light emitting diodes.

The display apparatus may further include a reflective sheet having a plurality of holes and configured to cover the first surface of the substrate.

The display apparatus may further include a plurality of optical domes on the first surface of the substrate, each of the plurality of optical domes being disposed inside a corresponding one of the plurality of holes.

The display apparatus may further include a plurality of light emitting diode groups, each of the plurality of light emitting diode groups including at least two light emitting diodes among the plurality of light emitting diodes.

Each of the plurality of optical domes may be configured to cover a corresponding one of the plurality of light emitting diode groups.

Each of the plurality of light emitting diode groups may include a red light emitting diode, a green light emitting diode, and a blue light emitting diode.

The display apparatus may further include a dimming block including light emitting diode groups among the plurality of light emitting diode groups, the light emitting diode groups being connected to be turned on or off simultaneously.

The antistatic member may extend along both sides of the power feeding line in the dimming block, from both sides of a first light emitting diode group forming one end of the dimming block toward both sides of a second light emitting diode group forming the other end of the dimming block.

The antistatic member may have a substantially closed curve shape with both ends open, so that a first end of the power feeding line connected to the first light emitting diode group and a second end of the power feeding line connected to the second light emitting diode group are not connected to the antistatic member and extend outside the dimming block.

The display apparatus may further include a protective layer configured to cover the first surface of the substrate, the protective layer having a first window provided to expose at least a portion of the power feeding pad and a second window provided to expose at least a portion of the antistatic member.

The antistatic member may include an antistatic pad exposed through the second window.

The antistatic pad may extend along both sides of the power feeding line, from both sides of the first light emitting diode toward both sides of the second light emitting diode.

According to an aspect of the disclosure, a display apparatus may include a liquid crystal panel and a backlight unit configured to provide light to the liquid crystal panel. The backlight unit may include: a substrate having a first surface and a second surface opposite to the first surface, the substrate including an insulating layer forming a part of the first surface and a conductive layer forming a remaining part of the first surface; a plurality of light emitting diodes configured to be mounted on the first surface of the substrate; a power feeding pad as a part of the conductive layer, provided to be in contact with the plurality of light emitting diodes; a power feeding line as a part of the conductive layer, connected to the power feeding pad; and an antistatic member as a part of the conductive layer, spaced apart from the power feeding pad and the power feeding line so as not to be connected to the power feeding pad and the power feeding line. The antistatic member may include a plurality of antistatic pads disposed apart from each other. The plurality of antistatic pads may form a dashed-line closed curve in which at least two of the plurality of light emitting diodes are disposed.

According to an aspect of the disclosure, a backlight unit including an antistatic member having an improved shape or structure to enhance the stability of a light source that has become vulnerable to electrostatic discharge due to the thinning of circuit patterns such as a power feeding line on a substrate, and a display apparatus including the same, can be provided.

According to an aspect of the disclosure, a backlight unit including an antistatic member configured to substantially surround a light emitting diode and a power feeding line to improve antistatic performance in all directions, and a display apparatus including the same, can be provided.

Although non-limiting example embodiments of the disclosure have been described above with reference to the accompanying drawings, it would be appreciated by those skilled in the art that changes and modifications may be made in these embodiments without departing from the spirit and scope of the disclosure.

What is claimed is:

1. A display apparatus comprising:
a liquid crystal panel; and
a backlight unit configured to provide light to the liquid crystal panel,
wherein the backlight unit comprises:
a substrate comprising an insulating layer and a conductive layer, the insulating layer defining a first part of a first surface of the substrate, and the conductive layer defining a second part of the first surface; and
a plurality of light emitting diodes on the first surface of the substrate;
wherein the conductive layer comprises:
at least one power feeding pad connected to the plurality of light emitting diodes;
at least one power feeding line connected to the at least one power feeding pad; and
an antistatic member spaced apart from the at least one power feeding pad and the at least one power feeding line so as not to be connected to the at least one power feeding pad and the at least one power feeding line, and
wherein the antistatic member comprises a closed curve in which at least two of the plurality of light emitting diodes are disposed.

2. The display apparatus of claim 1, wherein the backlight unit further comprises:
a dimming block comprising a set of light emitting diodes among the plurality of light emitting diodes, the set of light emitting diodes configured to be turned on or off simultaneously;
wherein the dimming block is in the closed curve of the antistatic member.

3. The display apparatus of claim 1, wherein the backlight unit further comprises:
a plurality of dimming blocks arranged in a matrix form on the first surface of the substrate, each of the plurality of dimming blocks comprising a respective set of the plurality of light emitting diodes,
wherein the respective set of the plurality of light emitting diodes are configured to be turned on or off simultaneously, and
wherein at least two adjacent dimming blocks among the plurality of dimming blocks are in the closed curve of the antistatic member.

4. The display apparatus of claim 1, wherein the backlight unit further comprises:
a reflective sheet including a plurality of holes, the reflective sheet being on the first surface of the substrate;
a plurality of optical domes on the first surface of the substrate, each of the plurality of optical domes inside a respective one of the plurality of holes; and
a plurality of light emitting diode groups, each of the plurality of light emitting diode groups comprising at least two light emitting diodes among the plurality of light emitting diodes,
wherein each of the plurality of optical domes covers a respective one of the plurality of light emitting diode groups.

5. The display apparatus of claim 4, wherein each of the plurality of light emitting diode groups comprises a red light emitting diode, a green light emitting diode, and a blue light emitting diode.

6. The display apparatus of claim 5, wherein the backlight unit further comprises:
a dimming block comprising at least two light emitting diode groups among the plurality of light emitting diode groups, the at least two light emitting diode groups configured to be turned on or off simultaneously;
wherein the dimming block is in the closed curve of the antistatic member.

7. The display apparatus of claim 1, wherein the backlight unit further comprises:
a protective layer on the first surface of the substrate, the protective layer including:
a first window that exposes at least a portion of the at least one power feeding pad; and
a second window that exposes at least a portion of the antistatic member;
wherein the antistatic member comprises an antistatic pad, the antistatic pad exposed through the second window, and
wherein the antistatic pad forms the closed curve, and at least one light emitting diode among the plurality of light emitting diodes is in the closed curve of the antistatic pad.

8. The display apparatus of claim 1, wherein the conductive layer is a first conductive layer,
wherein the insulating layer defines a first part of a second surface of the substrate, opposite to the first surface, and
wherein the substrate further comprises a second conductive layer, the second conductive layer defining a second part of the second surface.

9. The display apparatus of claim 8, wherein the substrate further includes a via hole that passes through the substrate,
wherein a first end of the at least one power feeding line is inside the closed curve, and
wherein the first end of the at least one power feeding line is connected to the second conductive layer through the via hole.

10. A display apparatus comprising:
a liquid crystal panel; and
a backlight unit configured to provide light to the liquid crystal panel,
wherein the backlight unit comprises:
a substrate comprising an insulating layer and a conductive layer, the insulating layer defining a first part of a first surface of the substrate, and the conductive layer defining a second part of the first surface; and
a plurality of light emitting diodes on the first surface of the substrate, the plurality of light emitting diodes comprising a first light emitting diode and a second light emitting diode,
wherein the conductive layer comprises:
at least one power feeding pad in contact with the plurality of light emitting diodes;
at least one power feeding line connected to the at least one power feeding pad; and
an antistatic member spaced apart from the at least one power feeding pad and the at least one power feeding line so as not to be connected to the at least one power feeding pad and the at least one power feeding line, and
wherein the antistatic member extends, along opposite sides of the at least one power feeding line, from opposite sides of the first light emitting diode to opposite sides of the second light emitting diode.

11. The display apparatus of claim 10, wherein the backlight unit further comprises:
a dimming block comprising the first light emitting diode and the second light emitting diode, the first light emitting diode and the second light emitting diode configured to be turned on or off simultaneously, and
wherein the at least one power feeding line connects the first light emitting diode and the second light emitting diode of the dimming block.

12. The display apparatus of claim 10, wherein the backlight unit further comprises:
a reflective sheet including a plurality of holes, the reflective sheet being on the first surface of the substrate;
a plurality of optical domes on the first surface of the substrate, each of the plurality of optical domes being inside a corresponding one of the plurality of holes; and
a plurality of light emitting diode groups, each of the plurality of light emitting diode groups including at least two light emitting diodes among the plurality of light emitting diodes,
wherein each of the plurality of optical domes is configured to cover a corresponding one of the plurality of light emitting diode groups.

13. The display apparatus of claim 12, wherein each of the plurality of light emitting diode groups comprises a red light emitting diode, a green light emitting diode, and a blue light emitting diode.

14. The display apparatus of claim 13, further comprising:
a dimming block comprising at least two light emitting diode groups among the plurality of light emitting diode groups, the at least two light emitting diode groups configured to be turned on or off simultaneously;
wherein the antistatic member extends, along opposite sides of the at least one power feeding line, from opposite sides of a first light emitting diode group among the at least two light emitting diode groups to opposite sides of a second light emitting diode group among the at least two light emitting diode groups, and
wherein one end of the dimming block comprises the first light emitting diode group, and a second end of the dimming block comprises the second light emitting diode group.

15. The display apparatus of claim 14, wherein the antistatic member comprises a curve shape in which the first light emitting diode group and the second light emitting diode group are provided,
wherein a first end of the curve shape and a second end of the curve shape are open,
wherein a first end of the at least one power feeding line is connected to the first light emitting diode group and a second end of the at least one power feeding line is connected to the second light emitting diode group, and
wherein the first end of the at least one power feeding line extends to an outside of the curve shape, through the first end of the curve shape, and is not connected to the antistatic member, and
wherein the second end of the at least one power feeding line extends to an outside of the curve shape, through the second end of the curve shape, and is not connected to the antistatic member.

16. A backlight unit of a display apparatus, the backlight unit comprising:
a substrate comprising an insulating layer and a conductive layer, the insulating layer defining a first part of a first surface of the substrate, and the conductive layer defining a second part of the first surface; and
a plurality of light emitting diodes on the first surface of the substrate;
wherein the conductive layer comprises:
at least one power feeding pad connected to the plurality of light emitting diodes;
at least one power feeding line connected to the at least one power feeding pad; and
an antistatic member spaced apart from the at least one power feeding pad and the at least one power feeding line so as not to be connected to the at least one power feeding pad and the at least one power feeding line, and
wherein the antistatic member comprises a shape in which at least two of the plurality of light emitting diodes are disposed.

17. The backlight unit of claim 16, further comprising:
a dimming block comprising a set of light emitting diodes among the plurality of light emitting diodes, the set of light emitting diodes configured to be turned on or off simultaneously;
wherein the dimming block is in the shape of the antistatic member.

18. The backlight unit of claim 16, further comprising:
a plurality of dimming blocks arranged in a matrix form on the first surface of the substrate, each of the plurality of dimming blocks comprising a respective set of the plurality of light emitting diodes,
wherein the respective set of the plurality of light emitting diodes are configured to be turned on or off simultaneously, and
wherein at least two adjacent dimming blocks among the plurality of dimming blocks are in the shape of the antistatic member.

19. The backlight unit of claim 16, further comprising:
a reflective sheet including a plurality of holes, the reflective sheet being on the first surface of the substrate;
a plurality of optical domes on the first surface of the substrate, each of the plurality of optical domes inside a respective one of the plurality of holes; and
a plurality of light emitting diode groups, each of the plurality of light emitting diode groups comprising at least two light emitting diodes among the plurality of light emitting diodes,
wherein each of the plurality of optical domes covers a respective one of the plurality of light emitting diode groups.

20. The backlight unit of claim 19, wherein each of the plurality of light emitting diode groups comprises a red light emitting diode, a green light emitting diode, and a blue light emitting diode.
